(19) United States
(12) Patent Application Publication
(10) Pub. No.: US 2011/0211775 A1
(43) Pub. Date: Sep. 1, 2011

(54) MESH BAG FOR AUTOMATED FILLING AND METHOD FOR MAKING SAME

(75) Inventors: Chris E. Worthington, Saint Paul, MN (US); Jeffrey L. Abramowski, Burnsville, MN (US); David M. Davis, Bishop, GA (US)

(73) Assignee: CONWED PLASTICS LLC, Minneapolis, MN (US)

(21) Appl. No.: 12/714,785

(22) Filed: Mar. 1, 2010

(51) Int. Cl. B65D 33/10; B65D 30/06; B31B 49/04

(52) U.S. Cl. 383/7; 383/117; 493/267

(57) ABSTRACT

The present invention provides a mesh bag for use with automated wicket bagging machines. In at least one embodiment, the mesh bag comprises a tubular mesh having a first end portion opposite a second end portion, a first wicketing strip attached to the second end portion of the mesh and having a peripheral edge, and a second wicketing strip attached to the second end portion of the mesh, wherein the second wicketing strip extends beyond a top edge of the mesh and the peripheral edge of the first wicketing strip and has at least one opening adapted for collating a plurality of mesh bags on one or more wicket pins. The present invention also relates to a method for making such bags.

### BACKGROUND OF THE INVENTION

1. Field of the Invention

The present invention relates to mesh bags for use with automated wicket bagging machines and a method for making the same.

2. Background Art

Mesh bags, such as those typically made of a synthetic resin netting or “mesh,” are commonly known in the art for their ability to keep produce and other articles fresh, due to their open-air nature. Wicket bagging machines—also known as “wicket baggers”—like mesh bags, are well-known in the art and are commonly used for automating the process of bagging food and other items. The use of mesh bags with wicket bagging machines has posed a number of problems and, as a result, at least two distinct types of bags have been developed in the art.

The first of these bags is known as a “film” or “poly” bag. This type of bag consists of a film material containing a number of apertures designed to allow for ventilation of the contained product. While useable with wicket bagging machines, such bags do not provide the level of ventilation offered by mesh bags. Moreover, their strength decreases as a function of the number of apertures contained in the film.

The second type of bag commonly known in the art is the so-called “combo bag.” This type of bag often combines a film front panel with a mesh back panel—although there are forms which contain at least a portion of mesh on both the front and the back of the bag. Combo bags can provide improved ventilation over film bags, but the incorporation of large areas of film still acts to limit the ventilation when compared to an all-mesh bag.

The greater ventilation provided by all-mesh bags can increase product shelf life for many types of produce. Moreover, in comparison with poly and combo bags, consumers appear to be more receptive to all-mesh bags because they can provide a greater ability to assess the quality of the packaged produce. However, these types of all-mesh or substantially all-mesh bags, commonly called “header” bags, are only presently capable of being packed manually or through semi-automated processes. As such, even though the use of header bags may be desirable for their increased ventilation and their preferable physical characteristics—which allow for superior assessment of produce quality—the current inefficient packing methods associated with them have slowed their widespread acceptance in the marketplace.

Another detriment with the use of both film and combo bags is that they are limited in the types of closures that can be used at the end of the bag that is sealed prior to filling. Often, such closures are limited to a plain, flat seal, or perhaps a gusseted seal. This limitation hinders the ability to add a handle or other useful feature to the closed end of these wicketed bags. Furthermore, knitted netting can be made softer than available types of layflat mesh and can thereby provide a benefit in the storage of soft-skinned produce such as apples and potatoes. Despite this advantage, however, knitted netting cannot be used in combo bags because the construction of such bags requires the use of layflat mesh. Although the use of wicket bagging machinery for packaging these types of produce is preferable from a packing-efficiency standpoint, the drawbacks inherent in poly and combo bags have forced many suppliers to rely on the inefficient process of manually packing such produce in header bags.

Due at least in part to the limitations of both poly and combo bag technologies, new machinery has been developed in the art to allow packing facilities to automatically pack certain produce items in bags constructed primarily of mesh. This machinery, commonly supplied by Giro, but also supplied by C-Pack and Sorma, is expensive to install and, in most facilities, must be maintained in addition to the wicket bagging machines already onsite for use with poly and combo bags. Even though it provides a feasible alternative to the manual packing of header bags, the Giro-style machinery is relatively costly and is not adapted for complimentary use with traditional bagging technologies. Additionally, when orders for produce packed in all-mesh—or substantially all-mesh—bags exceed the capacity of such machinery, workers must manually pack the remainder of the order while traditional wicket bagging machines sit idle. Accordingly, it would be beneficial to provide a mesh bag designed to be automatically filled by wicket bagging machines either as a supplement to, or in place of, Giro-style machinery.

In light of the foregoing, it would be advantageous to provide a mesh bag adapted for use with wicket bagging machines that can provide increased ventilation, enhance consumers' ability to assess produce quality, allow for a greater number of different closure styles to be used, and can utilize both knitted and extruded tubular netting of all types.

### SUMMARY OF THE INVENTION

In at least one embodiment of the present invention, the mesh bag comprises a tubular mesh having a first, closed, end portion opposite a second, opened, end portion. The mesh itself can be made of any suitable material, and in certain embodiments is made of an extruded or knitted plastic.

A first wicketing strip is attached to the second end portion of the mesh and has a peripheral edge, which in some embodiments extends beyond a top edge of the mesh. Additionally, a second wicketing strip is attached to the second end portion of the mesh. In at least some embodiments, the second wicketing strip extends beyond the top edge of the mesh and the peripheral edge of the first wicketing strip and has at least one opening adapted for collating a plurality of mesh bags on one or more wicket pins. The wicketing strips can be made of polyethylene-based film, but can be made of any suitable material and can be attached to the mesh in any suitable way, including by sewing, gluing, ultrasonic bonding, heat sealing, or heat staking. In at least one embodiment, the wicketing strips are attached to the outer surfaces of the respective mesh layers. In at least another embodiment, the first wicketing strip is attached to the outer surface of the first layer, while the second wicketing strip is attached to the inner surface of the second layer.

Furthermore, in some embodiments the two wicketing strips can be sealed to one another; this can be done either before or after they are attached to the mesh. In yet another embodiment, the second wicketing strip has one or more openings designed to accommodate the structure of the typical wicket bagging machine. The openings may be of any suitable shape and size. In at least one embodiment, the second wicketing strip includes one or more tear slits positioned for reducing the force needed for the mesh bag to be torn off one or more wicket pins.

The present invention also provides a method of forming a mesh bag for use with a wicket bagging machine. In at least one embodiment, the method comprises providing a tubular mesh having a first layer opposite a second layer and a first, closed end portion opposite a second end portion; and attaching first and second wicketing strips to the first and second layers, respectively, at the second end portion, with at least a portion of the second wicketing strip extending beyond a top edge of the mesh and a peripheral edge of the first wicketing strip; with the second wicketing strip having one or more openings adapted for collating a plurality of mesh bags on one or more wicket pins.

In certain embodiments of the present invention, one or more openings, adapted for collating a plurality of mesh bags on a wicket, are punched in the second wicketing strip prior to attaching the second wicketing strip to the second layer.

In at least one embodiment, the first and second wicketing strips are sealed to each other before being attached to the first and second layers, respectively, at the second end portion of the mesh.

In yet another embodiment, the first and second wicketing strips are attached to the first and second layers, respectively, by a method selected from a group consisting of sewing, gluing, ultrasonic bonding, heat sealing, and heat staking.

In still another embodiment, a header is attached to the first layer and the second layer at the first end portion by a method selected from a group consisting of sewing, gluing, ultrasonic bonding, heat sealing, and heat staking.

In some embodiments, the wicketing strips are attached to an outer surface of the respective mesh layers.

In still yet another embodiment, the first wicketing strip is attached to an outer surface of the first layer, while the second wicketing strip is attached to an inner surface of the second layer.

### BRIEF DESCRIPTION OF THE DRAWINGS

FIG. 1 is a front perspective view of a mesh bag made in accordance with an embodiment of the present invention;

FIG. 2 is a front perspective view similar to FIG. 1 showing a portion of a mesh bag made in accordance with an embodiment of the present invention;

FIG. 3 is the same as FIG. 2 except having a cutout section to display certain aspects of the mesh bag;

FIG. 4 is the same as FIG. 3 except showing the opposite side of the bag;

FIG. 5 is a front oblique view showing the layered structure of the open end of a mesh bag made in accordance with an embodiment of the present invention;

FIG. 6 is the same as FIG. 5 except showing the bag from the opposite side;

FIG. 7 is a front perspective view of a mesh bag made in accordance with an embodiment of the present invention; and

FIG. 8 is similar to FIG. 7 except showing the bag from the opposite side and displaying only a portion of the bag.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any claims and/or as a representative basis for teaching one skilled in the art to variously employ the present invention.

Except in examples, or where otherwise expressly indicated, all numerical quantities in this description used to indicate amounts of material or dimensions are to be understood as modified by the word “about” in describing the broadest scope of the invention. Practice within the numerical limits stated is generally preferred. Also, unless expressly stated to the contrary: the description of a group or class of materials as suitable or preferred for a given purpose in connection with the invention implies that mixtures of any two or more the members of the group or class are equally suitable for preferred; the first definition of an acronym or other abbreviation applies to all subsequent uses herein of the same abbreviation and applies mutatis mutandis to normal grammatical variations of the initially defined abbreviation; and, unless expressly stated to the contrary measurement of a property is determined by the same technique as previously or later referenced for the same property.

Referring to the drawings, an exemplary embodiment of a mesh bag of the present invention is generally designated as number 10. Bags of the present invention can be used in any number of applications, but are commonly used as packaging for fresh produce. In at least the disclosed embodiment, bag 10 is made of a tubular mesh 12, which as shown in the collapsed state, has a first layer 14 and a second layer 16 opposite the first layer, such that the two layers are generally parallel and in close proximity to each other.

The tubular mesh 12 may be made of any suitable material and by any suitable process known in the art. Commonly, such tubular mesh is formed from extruded plastic netting. Extruded netting typically comprises strands extruded from a die and has joints that are either formed within the die itself or immediately outside the die. Although there are many known configurations associated with extruded netting, square, diamond, and twill are some of the most common. Moreover, any number of different varieties of plastic can be used for this type of extruded netting; such varieties include, but are not limited to, polypropylene, polyethylene, nylon, polybutylene, and blends thereof.

In addition to mesh formed from extruded plastic netting, there is another common variety of mesh known in the art—mesh formed from knitted fibers. The fibers—also referred to as tapes—used to construct knitted mesh bags may comprise natural materials, such as cotton, or synthetic materials, such as any suitable type of plastic. In accordance with a preferred embodiment of the present invention, the tubular mesh is made from knitted high density polyethylene (HDPE). In some embodiments, the tubular mesh comprises olefinic plastics other than HDPE. In other embodiments, the tubular mesh comprises non-olefinic plastics or natural fibers. Furthermore, the tubular mesh 12 may be of any size but is preferably 12 to 24 inches in width as measured in its collapsed state. The length of the tubular mesh 12 can be varied dependent upon the capacity requirements of each particular bag.

In the illustrated embodiment, at a first end portion 18 of the tubular mesh 12, the first layer 14 and second layer 16 are sealed by a header 20. The header 20 may be attached to the first layer 14 and second layer 16 by sewing, gluing, ultrasonic bonding, heat sealing, heat staking, or any other suitable method known in the art. Additionally, the header 20 may comprise any number of closure elements including, but not limited to, film closures, paper labels, poly labels, clipping wire, metal clips, plastic clips, and resealable closures such as zip closures, peal-and-reseal adhesive closures, and others. Moreover, the closure element may optionally include finger or handle punches 22 designed for a user to more easily carry the bag.

In some embodiments, the first end portion 18 of the bag 10 may be closed without the use of a header 20. For instance, the first layer 14 and second layer 16 may be sealed together at the first end portion 18 by heat sealing or any other suitable method. One method of sealing the layers without the use of a header 20 is commonly known as tip welding.

In at least the illustrated embodiment, a first wicketing strip 26 is attached to the first layer 14 at a second end portion 28 of the mesh 12, opposite the first end portion 18. The relative position of the first end portion 18 to the second end portion 28 generally defines what is herein referred to as the bag's “lengthwise axis.” The first wicketing strip 26 has a peripheral edge 30 which, in a preferred embodiment, extends beyond a top edge 32 of the mesh 12 along the lengthwise axis. In other embodiments, the peripheral edge 30 is generally inline with the top edge 32 of the mesh 12. In still other embodiments, the peripheral edge 30 does not extend to, and is below, the top edge 32 of the mesh 12 along the lengthwise axis.

Additionally, a second wicketing strip 36 is attached to the second layer 16 at the second end portion 28 of the mesh 12, wherein a peripheral edge 38 of the second wicketing strip 36 extends beyond the top edge 32 of the mesh 12 and the peripheral edge 30 of the first wicketing strip 26 along the lengthwise axis. In some embodiments, the second wicketing strip 36 extends 0.5 to 5 inches beyond the peripheral edge 30 of the first wicketing strip 26 along the lengthwise axis. In a preferred embodiment, the second wicketing strip 36 extends 1 to 2 inches beyond the peripheral edge 30 of the first wicketing strip 26.

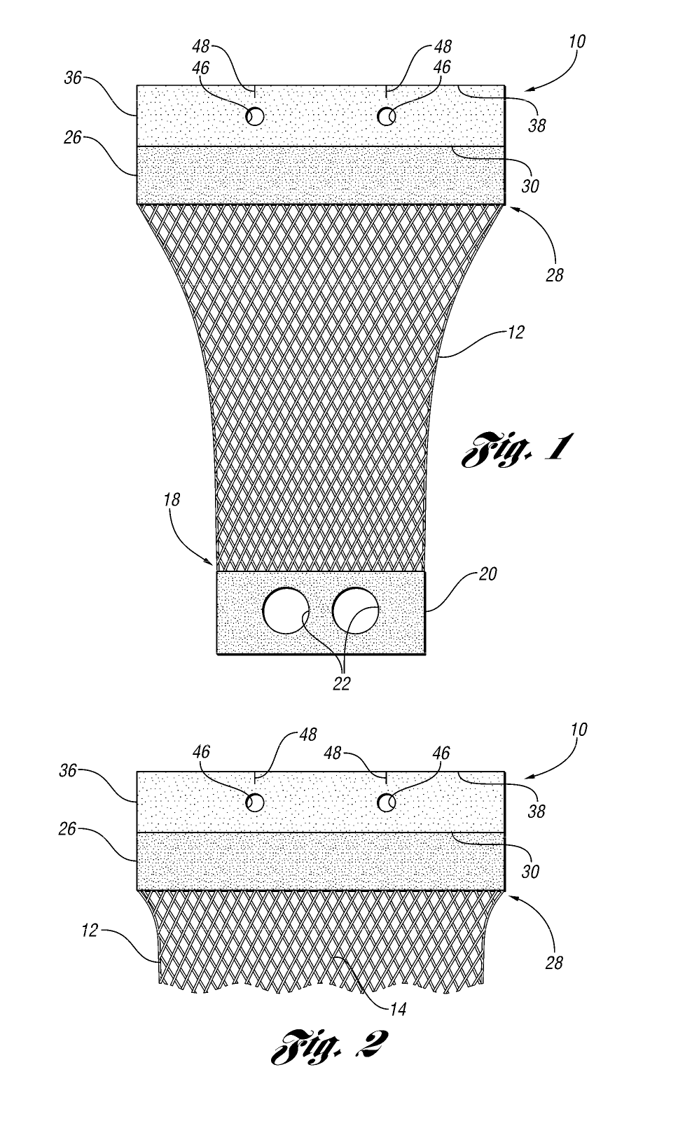

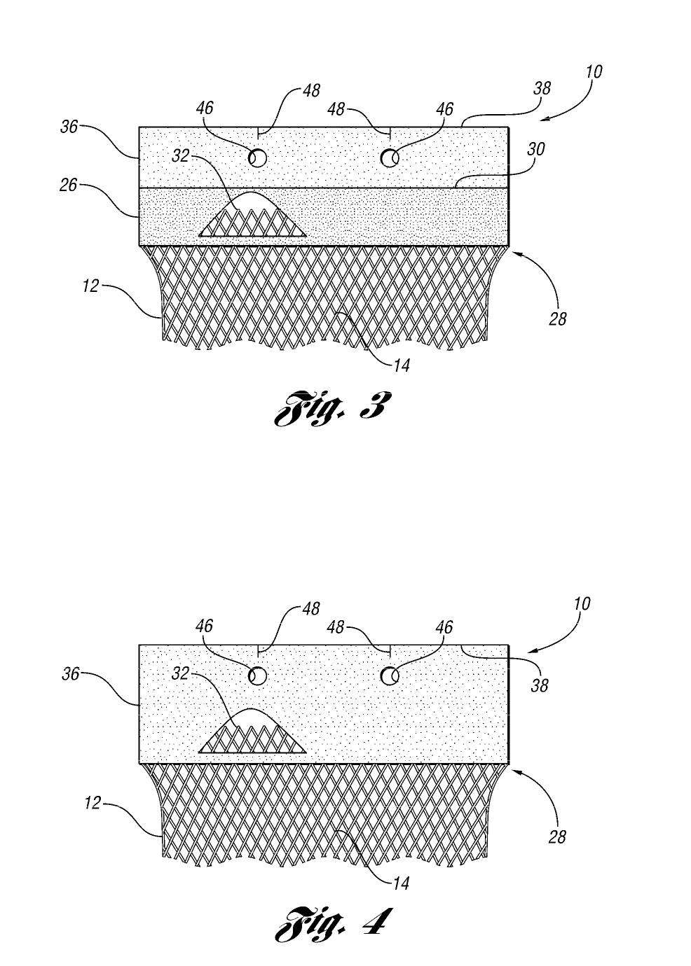

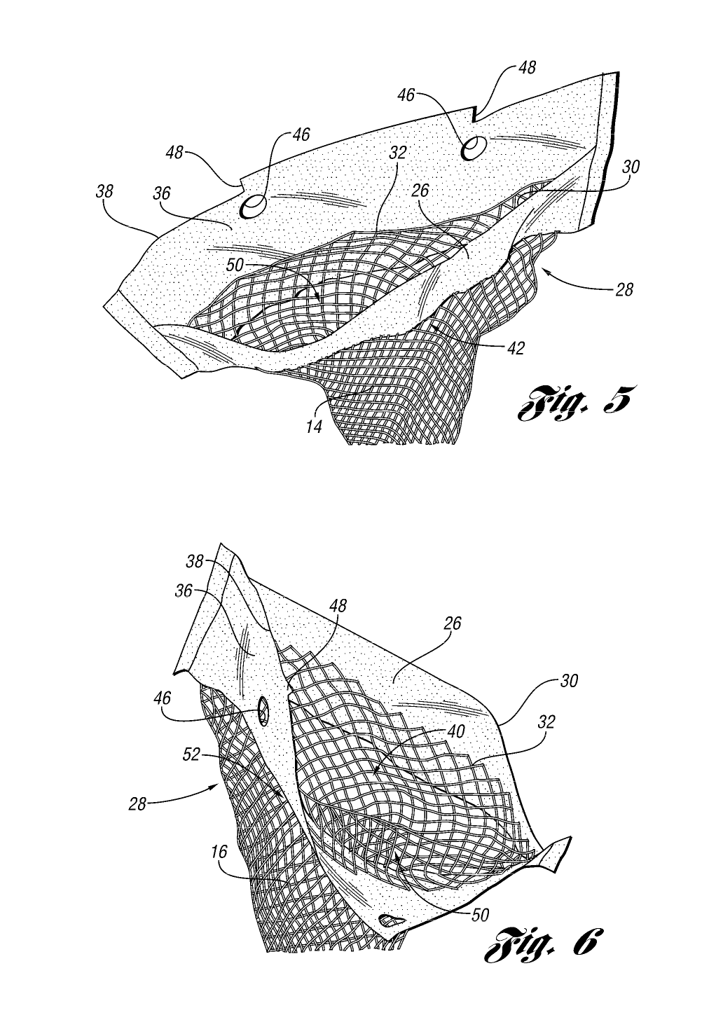

In at least the embodiments illustrated in FIGS. 1-6, the wicketing strips 26 and 36 are preferably rectangular in shape, however, it should be understood that they can be of any other shape. In at least one embodiment, the first wicketing strip 26 has a width, extending along the lengthwise axis, of 0.5 to 10 inches. In other embodiments the first wicketing strip 26 has a width of 0.75 to 5 inches and in yet other embodiments of 1 to 2 inches. Independent of the width of the first wicketing strip 26, the second wicketing strip 36 has a width, also extending along the lengthwise axis, of 0.5 to 15 inches in at least one embodiment. In other embodiments, the second wicketing strip 36 can have a width of 1 to 8 inches, and in yet other embodiments of 2 to 4 inches. Moreover, in at least one embodiment, the wicketing strips 26 and 36 have a length, extending generally transverse to the width, of 5 to 30 inches, in other embodiments, of 8 to 15 inches, and in yet other embodiments of 11 to 12 inches.

Preferably, the wicketing strips 26 and 36 are made of polyethylene-based film, but they can be made of any suitable material and can be attached to the mesh 12 in any suitable way, including by sewing, gluing, ultrasonic bonding, heat sealing, or heat staking. The wicketing strips 26 and 36 can be made of polyethylene-based film, non-polyethylene-based film, paper, or any number of other suitable materials known in the art. In a preferred embodiment, the wicketing strips 26 and 36 are made of low density polyethylene (LDPE) or linear low density polyethylene (LLDPE) and have a thickness of 1.25 to 2 mils. In some embodiments, the wicketing strips 26 and 36 have thicknesses of 0.5 to 5 mils, and in other embodiments of 1 to 3 mils.

Furthermore, in some embodiments the two wicketing strips 26 and 36 can be sealed to one another by any suitable method including sewing, gluing, ultrasonic bonding, heat sealing, and heat staking. In some embodiments this can be done prior to attaching the wicketing strips 26 and 36 to the mesh 12; while in other embodiments, the wicketing strips are sealed to one another after being attached to the mesh. By sealing the two wicketing strips 26 and 36, the opening created at the second end portion 28 of the mesh 12 can be limited to any desired size. The two wicketing strips 26 and 36 can be sealed to one another generally along a portion of their respective widths. In a preferred embodiment, the two wicketing strips 26 and 36 are sealed to one another along the entire distance of the overlap created by their respective widths. In other embodiments, the two wicketing strips 26 and 36 are sealed to one another both along their widths and along at least a portion of their respective lengths.

In accordance with a preferred embodiment of the present invention, the second wicketing strip 36 has at least one opening 46 adapted for collating a plurality of mesh bags on one or more wicket pins. In other embodiments, the second wicketing strip 36 has more than one opening. These openings 46 are designed to accept the wicket pins of a wicket bagging machine. In certain embodiments, the second wicketing strip 36 has exactly two openings 46 designed to accommodate the structure of the typical wicket bagging machine. These openings 46 may be of any shape and size, but are preferably round and located entirely within the second wicketing strip 36.

In an exemplary embodiment of the present invention, the second wicketing strip 36 has two openings 46 that each independently have a diameter of between 0.5 and 0.75 inches. In other embodiments the diameter of the openings 46 are from 0.375 to 1.25 inches. In at least one embodiment, the center of the openings 46 are positioned between 0.75 and 1.5 inches from the edge of the second wicketing strip 36. In other embodiments, the respective centers of openings 46 are positioned between 0.5 and 2 inches from the edge of the second wicketing strip 36. Commonly—and as shown in the exemplary embodiment illustrated in FIGS. 1-6—the openings 46 are spaced approximately five inches apart from one another, as most wicket bagging machines utilize wicket pins spaced five inches apart. However, it should be understood that the spacing may vary as desired, but will typically be found to be anywhere from 2 to 10 inches.

In accordance with automated bagging procedures known in the art, the bag 10 may be removed from the wicket pins either by ripping the second wicketing strip 36 off the wicket pins, such that the wicket pins sever the material of the wicketing strip above the provided opening(s) 46, or by sliding the second wicketing strip 36 off of the front of the wicket pins. In at least one embodiment, the second wicketing strip 36 also includes one or more tear slits 48 positioned for reducing the force needed for the mesh bag to be torn off one or more wicket pins. Such a result can often be achieved by positioning the tear slits 48 between the peripheral edge 38 of the second wicketing strip 36 and the opening or openings 46. In at least one embodiment, the tear slits 48 extend from the edge of the second wicketing strip 36 toward the opening or openings 46. In another embodiment, the tear slits 48 do not extend from the edge of the second wicketing strip 36, but instead are positioned entirely between the edge of the second wicketing strip 36 and the opening or openings 46. In still another embodiment, the tear slits 48 extend from the opening or openings 46 toward the edge of the second wicketing strip 36.

In at least the preferred embodiment, the tear slits 48 extend greater than 50% of the distance from the edge of the second wicketing strip 36 to the openings 46. In other embodiments, the tear slits 48 extend less than 50% of the distance from the edge of the second wicketing strip 36 to the openings 46. For instance, in some embodiments, the tear slits 48 extend from the edge of the second wicketing strip 36 to within 0.1 to 0.5 inches from the openings 46. In some embodiments, the tear slits 48 extend from 0.1 to 10 inches from the edge of the second wicketing strip 36 toward the openings 46.

The first and second layers 14 and 16 of the tubular mesh 12 each have an inner surface, 40 and 50, respectively, and an outer surface, 42 and 52, respectively. In the preferred embodiment, the first and second wicketing strips 26 and 36 are attached to the outer surfaces 42 and 52 of the first and second layers 14 and 16, respectively, at the second end portion 28 of the tubular mesh 12. Such an arrangement allows bags of the present invention to be reliably opened by automated wicket bagging machines and can provide a number of additional benefits.

The usual mode of operation of wicket bagging machines forms the basis for at least some of the beneficial effects achieved by such a bag structure. These machines typically operate by positioning one or more vacuum cups—designed to interact with a first layer of a wicketed bag—generally opposite the wicketing pins. To open a bag secured on its wicketing pins, the wicket bagging machine uses the vacuum cups to apply a suction force to the first layer of a wicketed bag such that, as the vacuum cups are moved away from the wicketing pins, the first layer is pulled away from the second layer creating an opening at one end of the bag. Once an opening is created, the wicket bagging machine uses mechanical grips to grip the first layer and to open the wicketed bag to its fully-open position.

In bags described herein, the first wicketing strip 26 is designed to interact with the vacuum cups of a wicket bagging machine. By attaching the first wicketing strip 26 to the outer surface 42 of the first layer 14, the vacuum cups are able to apply a relatively consistent suction to the wicketing strip, allowing for reliable opening of the bag 10 during operation of the wicket bagging machine. If the first wicketing strip 26 were instead attached to the inner surface 40 of the first layer 14, while still generally useable, the tubular mesh 12 could potentially interfere with the suction force created between the vacuum cups and the wicketing strip. The existence of mesh netting 12 between the vacuum cups and the first wicketing strip 26 would operate to significantly reduce the suction force created and would thereby hinder the wicket bagging machine's ability to consistently open the bag.

In addition to greater opening consistency, positioning the first wicketing strip 26 on the outer surface 42 of the first layer 14 allows the height of the first wicketing strip 26 to be reduced—limited only by the need to accommodate the size of the vacuum cups. This reduces the material cost of the bag and also improves sustainability by reducing the resultant bag's weight. Furthermore, attaching the first and second wicketing strips 26 and 36 to the outer surfaces 42 and 52 of the first and second layers 14 and 16, respectively, can provide large unbroken surface areas for the printing of information, graphics, or any type of identifying brand or logo. Further still, the slight separation of the wicketing strips 26 and 36 created by positioning the mesh netting between them—as is achieved by attaching the first and second wicketing strips 26 and 36 to the outer surfaces 42 and 52 of the first and second layers 14 and 16—reduces blocking between the layers of film. By reducing the level of blocking between the strips of film 26 and 36, the suction force required to open the bag 10 may also be reduced. The slight separation between the wicketing strips 26 and 36 may even allow the mechanical grips to open the bag 10 without the wicket bagging machine having to utilize its vacuum cups. Such operation would be especially useful in dirty and/or dusty packing environments (potato-packing environments, for example) in which the vacuum cups require frequent maintenance to ensure consistent operation.

Lastly, the separation of the first and second wicketing strips 26 and 36, provided by positioning them on the outer surfaces 42 and 52 of the first and second layers 14 and 16, may allow for the use of pressure sensitive adhesives (PSAs) in the joining of the wicketing strips 26 and 36 to the mesh 12. The use of PSAs would allow the wicketing strips 26 and 36 and the mesh 12 to be made of materials that cannot be heat sealed or hot-melted together. Such materials include plastic film and cotton knitted netting. Additionally, the use of PSAs could be advantageous in the production mesh bags made entirely with renewable materials such as paper and natural fibers. For example, PSAs could be used to join wicketing strips 26 and 36 and header 20, all made of paper, to a knitted netting mesh 12 made of a natural fiber such as cotton.

In still another embodiment of the present invention, the first wicketing strip 26 is attached to the outer surface 42 of the first layer 14 while the second wicketing strip 36 is attached to the inner surface 50 of the second layer 16.

The header 20 is preferably attached to the outer surfaces 42 and 52 of the first and second layers 14 and 16, respectively. Alternatively, the header 20 may be attached to the inner surfaces 40 and 50 of the first and second layers 14 and 16 without deviating from the scope of the present invention.

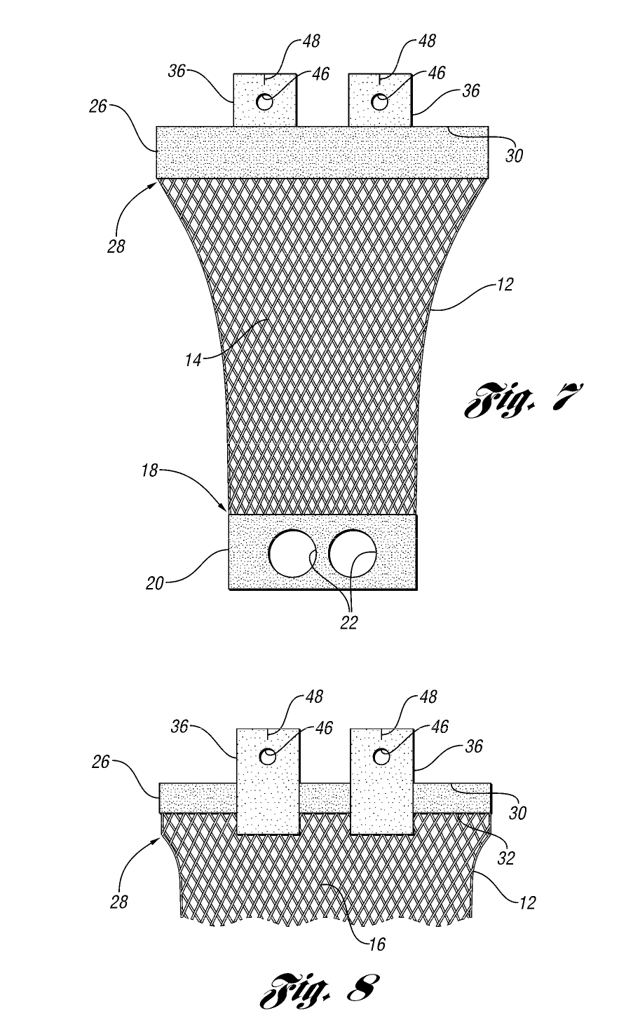

Referring to the embodiment shown in FIGS. 7 and 8, a bag 10 may comprise two distinct second wicketing strips 36 which are each attached to the second layer 16 at the second end portion 28 of the mesh 12. Each of the two second wicketing strips 36 extends beyond the top edge 32 of the mesh 12 and the peripheral edge 30 of the first wicketing strip 26 along the lengthwise axis. In at least the disclosed embodiment illustrated in FIGS. 7 and 8, the second wicketing strips 36 are rectangular in shape and each contains an opening 46 adapted for collating a plurality of mesh bags on one or more wicket pins and a tear slit 48 positioned for reducing the force needed for the mesh bag to be torn off one or more wicket pins.

The present invention also provides a method of forming a mesh bag 10 for use with a wicket bagging machine. In at least one embodiment, the method comprises providing a tubular mesh 12 having a first layer 14 and a second layer 16 and a first end portion 18 and a second end portion 28; attaching a header 20 to the first and second layers 14 and 16 at the first end portion 18, the header 20 sealing the first and second layers 14 and 16. Once the tubular mesh has been provided, first and second wicketing strips 26 and 36 are attached to the first and second layers 14 and 16, respectively, at the second end portion 28 so that at least a portion of the second wicketing strip 36 extends beyond a top edge 32 of the mesh 12 and a peripheral edge 30 of the first wicketing strip 26 along the lengthwise axis. Finally, one or more openings 46 are punched in the second wicketing strip 36 adapted for collating a plurality of mesh bags on one or more wicket pins. In some embodiments, one or more openings 46, adapted for collating a plurality of mesh bags on a wicket, are punched in the second wicketing strip 36 prior to attaching the second wicketing strip 36 to the second layer 16.

According to the method of the present invention, the header 20 may be attached to the first layer 14 and second layer 16 by sewing, gluing, ultrasonic bonding, heat sealing, or any other suitable method known in the art. Additionally, the header 20 may comprise any number of closure elements including, but not limited to, film closures, paper labels, poly labels, and resealable closures such as zip closures, peal-and-reseal adhesive closures, and others. Moreover, the closure element may optionally include finger or handle punches 22 designed for a user to more easily carry the bag. In some embodiments of the method, the first layer 14 and second layer 16 may be sealed together at the first end portion 18 without the use of a header 20 by heat sealing or any other suitable method.

The wicketing strips 26 and 36 are preferably rectangular in shape but can be of any other shape while remaining within the scope of the present invention. Preferably, the wicketing strips 26 and 36 are made of polyethylene-based film, but they can be made of any suitable material and can be attached to the mesh 12 in any suitable way, including by sewing, gluing, ultrasonic bonding, or heat sealing. In at least one embodiment, the wicketing strips 26 and 36 are attached to an outer surface 42 and 52 of the respective mesh layers 14 and 16. Furthermore, in certain embodiments, the first and second wicketing strips 26 and 36 are sealed to each other before being attached to the first and second layers 14 and 16, respectively, at the second end portion 28 of the mesh 12. In other embodiments, the first and second wicketing strips 26 and 36 are sealed to each other after being attached to the first and second layers 14 and 16, respectively, at the second end portion 28 of the mesh 12.

In at least one other embodiment of the method, the wicketing strips 26 and 36 are attached to an outer surface 42 and 52 of the respective mesh layers 14 and 16. In at least another embodiment, the first wicketing strip 26 is attached to the outer surface 42 of the first layer 14, while the second wicketing strip 36 is attached to the inner surface 50 of the second layer 16.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A mesh bag comprising:
a tubular mesh having a first end portion opposite a second end portion, the first end portion being closed and the second end portion being opened;
a first wicketing strip attached to the second end portion of the mesh, the first wicketing strip having a peripheral edge; and
a second wicketing strip attached to the second end portion of the mesh, wherein the second wicketing strip extends beyond a top edge of the mesh and the peripheral edge of the first wicketing strip, the second wicketing strip having at least one opening adapted for collating a plurality of mesh bags on one or more wicket pins, the first and second strips secured to the mesh so that at least some of the mesh is disposed between the first and second strips.

2. The mesh bag of claim 1 wherein the mesh has an inner surface and an outer surface, the first and second wicketing strips being attached to the outer surface of the mesh, at the second end portion.

3. The mesh bag of claim 1 wherein the peripheral edge of the first wicketing strip extends beyond the top edge of the mesh.

4. The mesh bag of claim 1 wherein the peripheral edge of the first wicketing strip extends to the top edge of the mesh.

5. The mesh bag of claim 1 wherein the tubular mesh is made of extruded plastic.

6. The mesh bag of claim 1 wherein the tubular mesh is made of a knitted fiber.

7. The mesh bag of claim 1 wherein the first and second wicketing strips are made of polyethylene-based film.

8. The mesh bag of claim 7 wherein the first and second wicketing strips are sealed to each other.

9. The mesh bag of claim 1 wherein the first and second wicketing strips are made of paper.

10. The mesh bag of claim 1 wherein the second wicketing strip includes one or more tear slits positioned for reducing the force needed for the mesh bag to be torn off one or more wicket pins.

11. The mesh bag of claim 1 wherein the first wicketing strip is attached to the outer surface of the mesh and the second wicketing strip is attached to the inner surface of the mesh.

12. The mesh bag of claim 1 wherein a header is disposed at the first end portion of the mesh to at least assist in sealing the first end portion of the mesh.

13. The mesh bag of claim 1 further comprising a third wicketing strips attached adjacent the second wicketing strip at the second end portion of the mesh, the third wicketing strip having at least one opening adapted for collating a plurality of mesh bags on one or more wicket pins.

14. The mesh bag of claim 1 wherein the second wicketing strip extends 0.5 to 5 inches beyond the peripheral edge of the first wicketing strip.

15. The mesh bag of claim 14 wherein the second wicketing strip extends 1 to 2 inches beyond the peripheral edge of the first wicketing strip.

16. The mesh bag of claim 12 wherein the header comprises a closure element selected from a group consisting of film closures, paper labels, poly labels, clipping wire, metal clips, plastic clips, and resealable closures.

17. The mesh bag of claim 16 wherein the closure element includes finger or handle punches.

18. A mesh bag comprising:
a tubular mesh having a first layer opposite a second layer and a first end portion opposite a second end portion, the first and second layers each having an inner surface and an outer surface, the second end portion being closed;
a first wicketing strip attached to the outer surface of the first layer at the second end portion of the mesh, the first wicketing strip having a peripheral edge which extends beyond the second end portion of the mesh; and
a second wicketing strip attached to the second end portion of the mesh, wherein the second wicketing strip extends beyond the second end portion of the mesh and the peripheral edge of the first wicketing strip, the second wicketing strip having at least one opening adapted for collating a plurality of mesh bags on one or more wicket pins.

19. A method of forming a mesh bag, the method comprising:
providing a tubular mesh having a first layer opposite a second layer and a closed end portion opposite an opened end portion; and
attaching first and second wicketing strips to the first and second layers, respectively, at the opened end portion, with at least a portion of the second wicketing strip extending beyond a top edge of the mesh and a peripheral edge of the first wicketing strip;
the second wicketing strip having one or more openings adapted for collating a plurality of mesh bags on one or more wicket pins.

20. The method of claim 19 wherein the first and second wicketing strips are attached to outer surfaces of the first and second layers, respectively.

21. The method of claim 19 wherein the first wicketing strip is attached to an outer surface of the first layer and the second wicketing strip is attached to an inner surface of the second layer.

22. The method of claim 19 wherein the first and second wicketing strips are sealed to each other before being attached to the first and second layers, respectively, at the second end portion of the mesh.

23. The method of claim 19 further comprising sealing the first and second wicketing strips to each other after being attached to the first and second layers, respectively, at the second end portion of the mesh.

24. The method of claim 19 wherein the first and second layers are sealed to each other by a header.
